(19) United States
(12) Patent Application Publication
(10) Pub. No.: US 2015/0040463 A1
(43) Pub. Date: Feb. 12, 2015

(54) Support Device For A Fishing Reel

(71) Applicant: Yi-Te Lin, Tainan (TW)

(72) Inventor: Yi-Te Lin, Tainan (TW)

(21) Appl. No.: 13/963,401

(22) Filed: Aug. 9, 2013

(51) Int. Cl. A01K 87/06; A01K 87/08

(52) U.S. Cl. CPC A01K 87/06; A01K 87/08
USPC 43/22

(57) ABSTRACT

A support device includes a body and a positioning device mounted on the body for coupling with a fishing reel. A longitudinal hole for receiving a fishing rod extends from a front end through a rear end of the body. A gripping portion is provided on the rear end and includes a coupling portion for coupling with the fishing reel. A finger of a user can grip the front section and can touch a surface section of the fishing rod via a lower opening in a front section of a lower side of the gripping portion. Another finger of the user can grip the rear section and can touch another surface section of the fishing rod via a lateral through-hole formed in a rear section of the lower side and extending from a left side through a right side of the body.

### BACKGROUND OF THE INVENTION

The present invention relates to a support device for a fishing reel and, more particularly, to a support device allowing a user to feel vibrations of a fishing rod in different orientations while providing enhanced engagement reliability with a fishing reel.

A fishing rod is generally equipped with a support device for mounting a fishing reel. The support device is generally tubular and includes a longitudinal hole through which the fishing rod extends. A coupling portion is provided on an upper or lower side of the support device to couple with the fishing reel. Furthermore, the support device is configured to allow easy gripping by a hand of a user such that the user can hold the support device to control winding and releasing of the fishing line. However, the hand of the user can not directly feel slight vibrations of the fishing rod when a fish is hooked, failing to provide an instant feedback of the fishing status.

In an approach to improve the sensitivity, the fishing reel includes a through-hole in an upper or lower side thereof. The through-hole of the fishing reel intersects with the longitudinal hole of the support device such that the fingers of the user can directly contact the fishing rod to sense fish biting. However, the fingers of the user can not easily identify the orientation of the vibrations of the fishing rod although the vibrations can be sensed. For example, the side-to-side vibrations of the fishing rod can not be easily sensed if the through-hole extends in a vertical direction. Thus, it is difficult to know the movement of the fish. Furthermore, the fishing reel withstanding the pulling force of the fish is apt to disengage from the support device during fishing due to unreliable engagement therebetween.

### BRIEF SUMMARY OF THE INVENTION

An objective of the present invention is to provide a support device allowing a user to feel vibrations of a fishing rod in different orientations while providing enhanced engagement reliability with a fishing reel.

A support device for a fishing reel includes a body and a positioning device mounted on the body and adapted to couple with a fishing reel. The body includes front and rear ends and left and right sides. A longitudinal hole extends from the front end through the rear end in a longitudinal direction. The longitudinal hole is adapted for receiving a fishing rod. A threaded portion is provided on the front end. A gripping portion is provided on the rear end and includes a coupling portion. The coupling portion is adapted to couple with an engagement piece of the fishing reel. The gripping portion includes a lower side having a front section and a rear section. The front section has a lower opening in communication with the longitudinal hole. The rear section includes a lateral through-hole extending from the left side through the right side of the body and intersecting with the longitudinal hole of the body. A finger of a user of the fishing rod is adapted to grip the front section and adapted to touch a surface section of the fishing rod via the lower opening. Another finger of the user adapted to grip the rear section and adapted to touch another surface section of the fishing rod via the lateral through-hole.

Preferably, each of the left and right sides of the body includes a slant surface in an area surrounding the lateral through-hole. The slant surface on each of the left and right sides extends towards the lateral through-hole.

Preferably, the threaded portion of the body includes a guiding groove extending in the longitudinal direction. The coupling portion includes a support face and a groove behind the support face. The engagement piece of the fishing reel has a rear end adapted to be engaged in the groove. The positioning device is adapted to engage with a front end of the engagement piece of the fishing reel. The positioning device includes a movable sleeve, a movable ring, and a positioning ring. The movable sleeve includes a central hole receiving the threaded portion of the body. The movable sleeve further has an insertion groove above the central hole. The insertion groove is adapted to receive the front end of the engagement piece of the fishing reel. A protrusion is formed on an inner periphery of the central hole of the movable sleeve. The protrusion is engaged in the guiding groove. The movable ring is pivotably connected to a front end of the movable sleeve. The movable ring includes a screw hole threadedly engaged with the threaded portion of the body such that the movable ring is threadedly engaged with the threaded portion of the body and such that the movable ring is rotatable to adjust a position of the movable sleeve in the longitudinal direction of the body. The positioning ring includes a screw hole threadedly engaged with the threaded portion of the body. The positioning ring is located in front of the movable ring and has a side abutting a side of the movable ring opposite to the movable sleeve.

The present invention will become clearer in light of the following detailed description of illustrative embodiments of this invention described in connection with the drawings.

### DESCRIPTION OF THE DRAWINGS

FIG. 1 is an exploded, perspective view of a support device for a fishing reel according to the present invention.

FIG. 2 is a perspective view of the support device of FIG. 1.

FIG. 3 is a cross sectional view taken along section line A-A of FIG. 2.

FIG. 4 is a cross sectional view taken along section line B-B of FIG. 2.

FIG. 5 is a longitudinal cross sectional view of the support device of FIG. 1, with the support device held by a right hand of a user.

FIG. 6 is a longitudinal cross sectional view of the support device of FIG. 1, with the support device held by a left hand of a user.

### DETAILED DESCRIPTION OF THE INVENTION

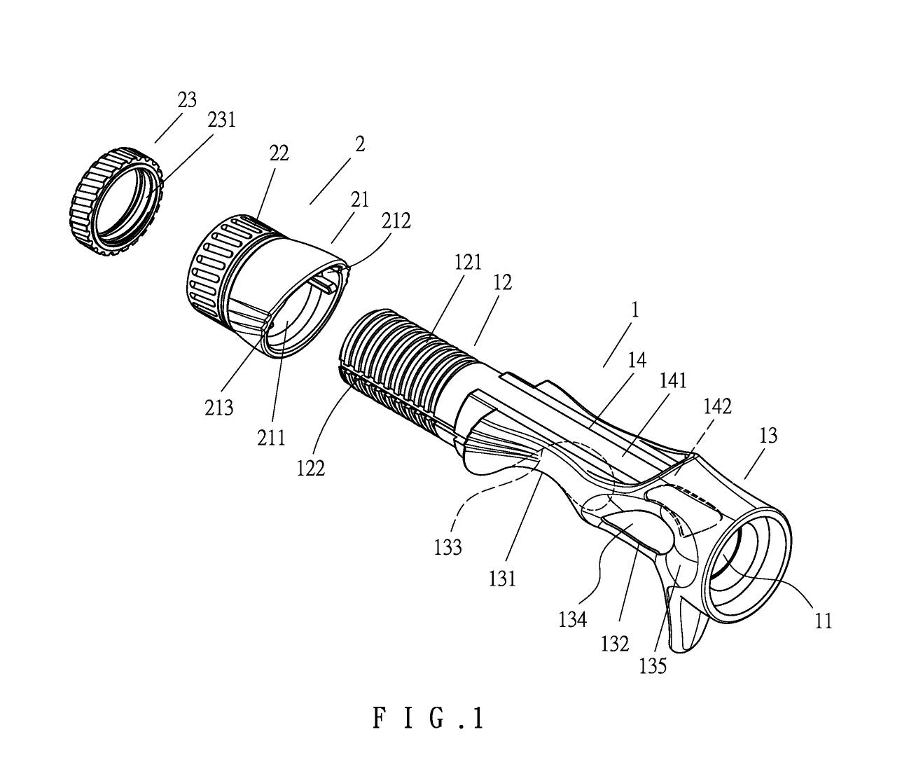

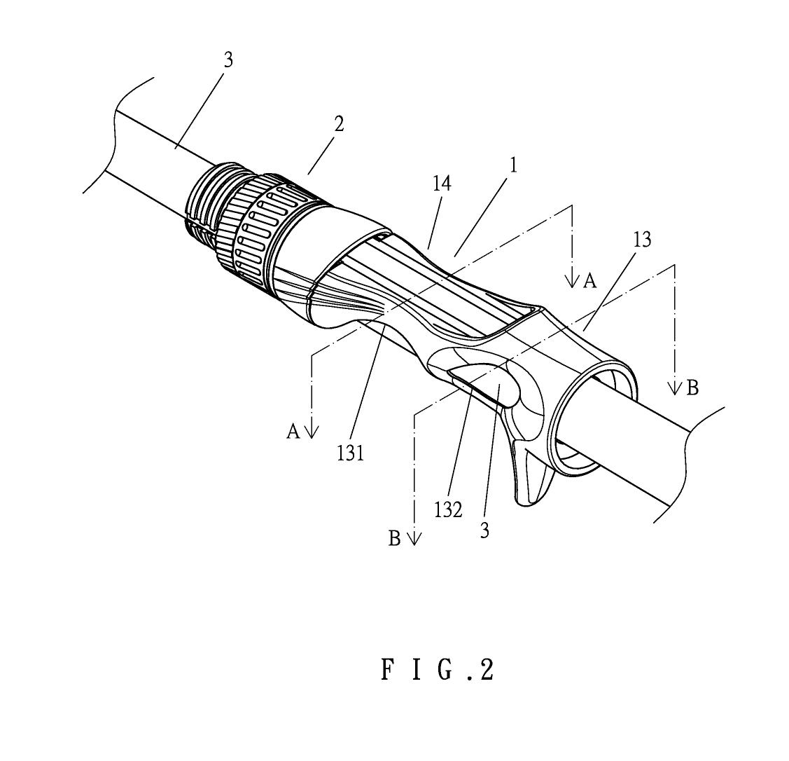

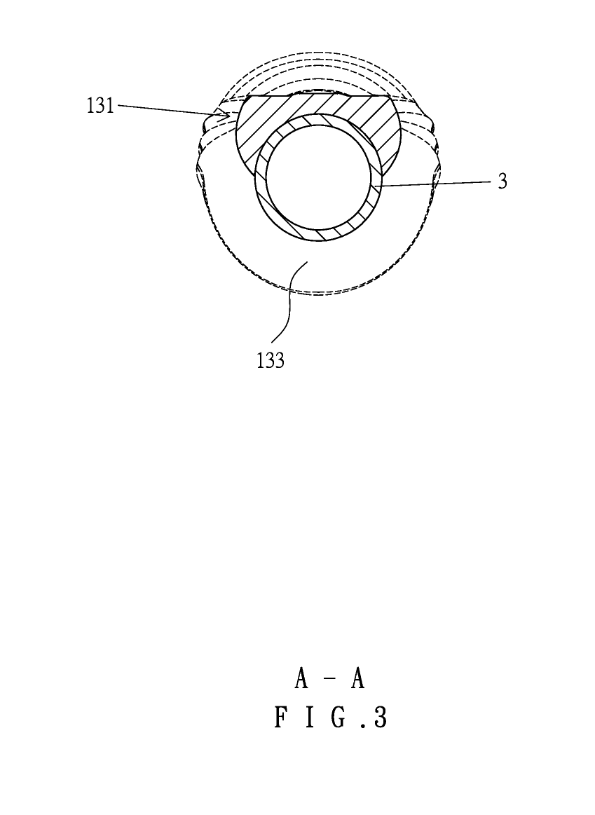

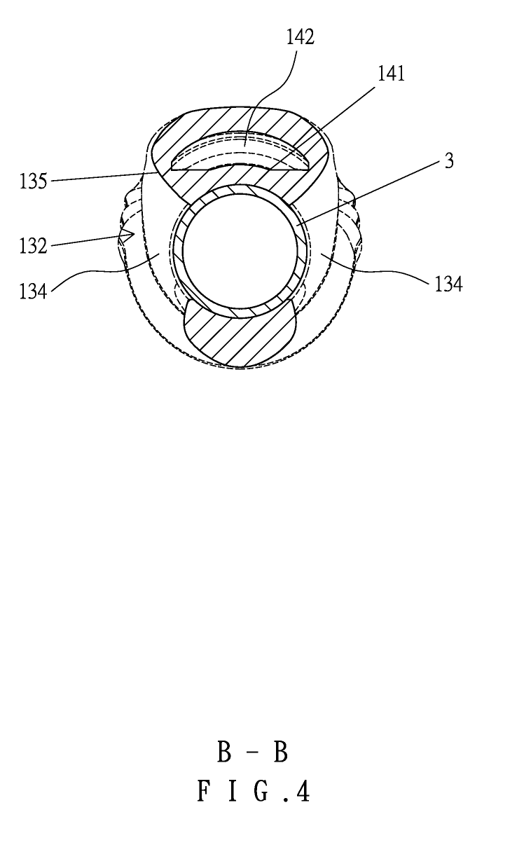

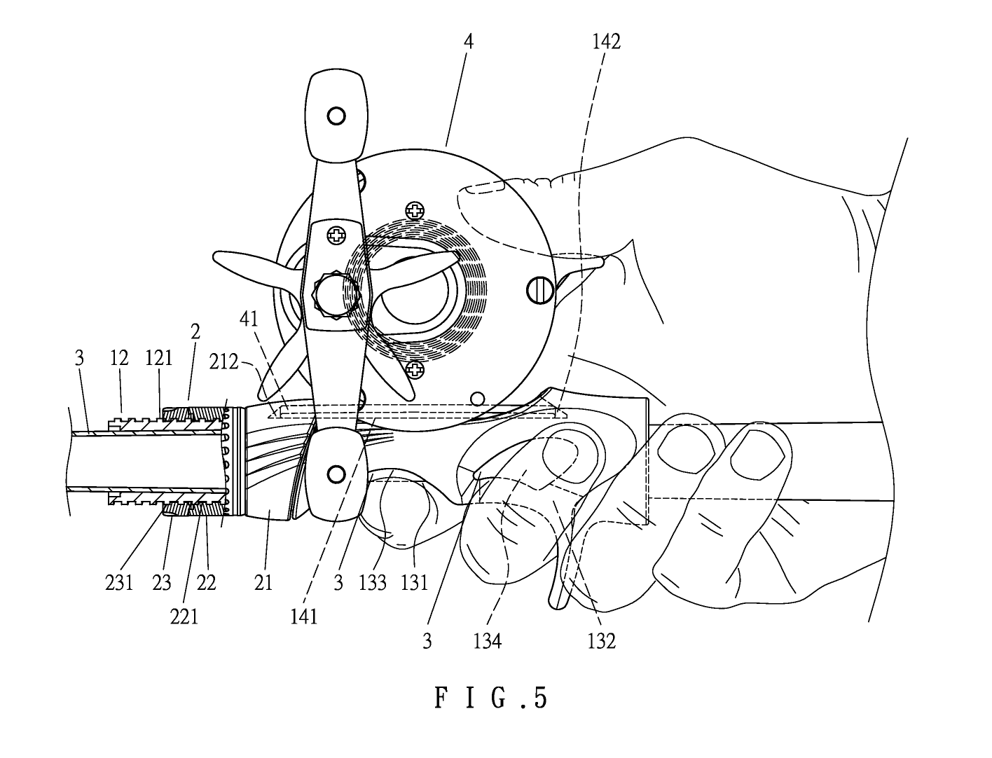

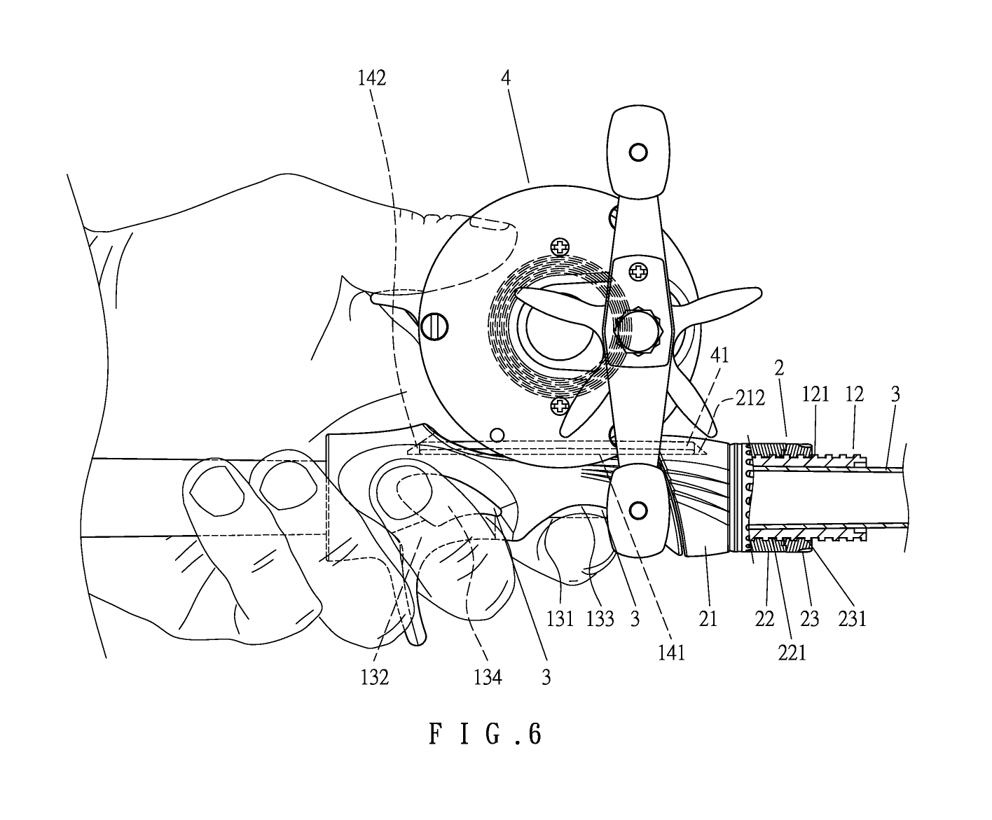

With reference to FIGS. 1-6, a support device for a fishing reel according to the present invention includes a body 1 and a positioning device 2. The body 1 is tubular and includes front and rear ends and left and right sides. A longitudinal hole 11 extends from the front end through the rear end in a longitudinal direction. The longitudinal hole 11 is adapted for receiving a fishing rod 3. A threaded portion 12 is provided on the front end and includes a thread 121 and a guiding groove 122 extending in the longitudinal direction. A gripping portion 13 is provided on the rear end and includes a coupling portion 14. The coupling portion 14 is adapted to couple with an engagement piece 41 of a fishing reel 4. The coupling portion 14 includes a support face 141 and a groove 142 behind the support face 141. The engagement piece 41 of the fishing reel 4 has a rear end adapted to be engaged in the groove 142. The gripping portion 13 includes a lower side having a front section 131 and a rear section 132. The front section 131 has a lower opening 133 in communication with the longitudinal hole 11. The rear section 132 includes a lateral through-hole 134 extending from the left side through the right side of the body 1 and intersecting with the longitudinal hole 11 of the body 1. Each of the left and right sides of the body 1 includes a slant surface 135 in an area surrounding the lateral through-hole 134. The slant surface 135 on each of the first and second sides extends towards the lateral through-hole 134.

The positioning device 2 is mounted on the body 1 and adapted to couple with a front end of an engagement piece 41 of the fishing reel 4. The positioning device 2 includes a movable sleeve 21, a movable ring 22, and a positioning ring 23. The movable sleeve 21 includes a central hole 211 receiving the threaded portion 121 of the body 1. The movable sleeve 21 further includes an insertion groove 212 above the central hole 211. The insertion groove 212 is adapted to receive the front end of the engagement piece 41 of the fishing reel 4. A protrusion 213 is formed on an inner periphery of the central hole 211 of the movable sleeve 21 and engaged in the guiding groove 122. The movable sleeve 21 is movable relative to the body 1 in the longitudinal direction. The movable ring 22 is pivotably connected to a front end of the movable sleeve 21. The movable ring 22 includes a screw hole 221 threadedly engaged with the threaded portion 12 of the body 1 such that the movable ring 22 is threadedly engaged with the threaded portion 12 of the body 1 and such that the movable ring 22 is rotatable to adjust a position of the movable sleeve 21 in the longitudinal direction of the body 1. The positioning ring 23 includes a screw hole 231 threadedly engaged with the threaded portion 12 of the body 1. The positioning ring 23 is located in front of the movable ring 22 and has a side abutting a side of the movable ring 22 opposite to the movable sleeve 21, preventing the movable sleeve 21 and the movable ring 22 from moving forward in the longitudinal direction.

The engagement piece 41 of the fishing reel 4 is placed on the support face 141 of the body 1, with the rear end of the engagement piece 41 inserted into the groove 142 in the rear end of the body 1. The movable ring 22 is rotated to move the movable seat 21 rearwards until the insertion groove 212 of the movable sleeve 21 is engaged with the front end of the engagement piece 41 of the fishing reel 4. The fishing reel 4 is mounted on the support device. The positioning ring 23 is rotated to a position abutting the movable ring 22 to prevent the movable ring 22 from moving forward in the longitudinal direction of the body 1, reliably preventing the fishing reel 4 from disengaging from the support device.

In use, the index finger of a user of the fishing rod 3 can grip the front section 131 and can touch a surface section of the fishing rod 3 via the lower opening 133. Furthermore, the middle finger of the user can grip the rear section 132 and can touch another surface section of the fishing rod 3 via the lateral through-hole 134. The slant surfaces 135 allow the middle finger of the user to slide into the lateral through-hole 134 and touch the corresponding surface section of the fishing rod 3. Since the lateral through-hole 134 extends from the left side through the right side of the body 1, the user can hold the fishing rod with either the right hand or the left hand while touching the corresponding surface section of the fishing rod 3. Vibrations of the fishing rod 3 resulting from movement of the fish during fishing can be sensed by the middle finger and/or the index finger of the user through the lateral through-hole 134 and the lower opening 133. Thus, the user can more precisely sense the vibration orientation of the fishing rod 3 and can have an instant feedback of the fishing status.

Although specific embodiments have been illustrated and described, numerous modifications and variations are still possible without departing from the scope of the invention. The scope of the invention is limited by the accompanying claims.

1. A support device for a fishing reel comprising:
a body including front and rear ends and left and right sides, with a longitudinal hole extending from the front end through the rear end in a longitudinal direction, with the longitudinal hole adapted for receiving a fishing rod, with a threaded portion provided on the front end, with a gripping portion provided on the rear end and including a coupling portion, with the coupling portion adapted to couple with an engagement piece of a fishing reel, with the gripping portion including a lower side having a front section and a rear section, with the front section having a lower opening in communication with the longitudinal hole, with the rear section including a lateral through-hole extending from the left side through the right side of the body and intersecting with the longitudinal hole of the body, with a finger of a user of the fishing rod adapted to grip the front section and adapted to touch a surface section of the fishing rod via the lower opening, with another finger of the user adapted to grip the rear section and adapted to touch another surface section of the fishing rod via the lateral through-hole; and
a positioning device mounted on the body, with the positioning device adapted to couple with the fishing reel.

2. The support device for a fishing reel as claimed in claim 1, with each of the left and right sides of the body including a slant surface in an area surrounding the lateral through-hole, with the slant surface on each of the left and right sides extending towards the lateral through-hole.

3. The support device for a fishing reel as claimed in claim 1, with the threaded portion of the body including a guiding groove extending in the longitudinal direction, with the coupling portion including a support face and a groove behind the support face, with the engagement piece of the fishing reel having a rear end adapted to be engaged in the groove, with the positioning device adapted to engage with a front end of the engagement piece of the fishing reel, with the positioning device including a movable sleeve, a movable ring, and a positioning ring, with the movable sleeve including a central hole receiving the threaded portion of the body, with the movable sleeve further having an insertion groove above the central hole, with the insertion groove adapted to receive the front end of the engagement piece of the fishing reel, with a protrusion formed on an inner periphery of the central hole of the movable sleeve, with the protrusion engaged in the guiding groove, with the movable ring pivotably connected to a front end of the movable sleeve, with the movable ring including a screw hole, with the screw hole threadedly engaged with the threaded portion of the body such that the movable ring is threadedly engaged with the threaded portion of the body and such that the movable ring is rotatable to adjust a position of the movable sleeve in the longitudinal direction of the body, with the positioning ring including a screw hole, with the screw hole of the positioning ring threadedly engaged with the threaded portion of the body, with the positioning ring located in front of the movable ring, with the positioning ring having a side abutting a side of the movable ring opposite to the movable sleeve.
